(19) United States
(12) Patent Application Publication
(10) Pub. No.: US 2014/0290124 A1
(43) Pub. Date: Oct. 2, 2014

(54) Bed Bug Elimination Systems and Methods

(71) Applicant: Christopher M. Aidan, Austin, TX (US)

(72) Inventor: Christopher M. Aidan, Austin, TX (US)

(21) Appl. No.: 13/851,715

(22) Filed: Mar. 27, 2013

(51) Int. Cl. A01M 1/20; A01M 1/02

(52) U.S. Cl. CPC A01M 1/2094; A01M 1/02
USPC 43/132.1

(57) ABSTRACT

Systems to eliminate bed bugs may generally comprise a travel article and a heating mechanism to elevate the temperature of the travel article and/or the travel article contents. The travel article may comprise a suit case, luggage, bag, backpack, garment bag, laptop bag, tote bag, purse, trunk and the like.

Additionally, the system to eliminate bed bugs may further comprise a collapsible portable enclosure suitable for a traveler to transport the portable enclosure within the travel article, wherein the portable enclosure in an expanded form may comprise a volume sufficient to enclose the travel article, travel article contents, or any other item for which the user wishes to elevate the temperature of the item so as to eliminate bed bugs

Among various representative embodiments, bed bug elimination may comprise a method for manufacturing, packaging, marketing and/or selling the bed bug elimination system or device.

### BACKGROUND OF THE INVENTION

Bed bugs have recently resurged as a problematic insect, which feed exclusively on blood. They prefer warm areas and maintain a habitat in close proximity to their preferred host to accommodate the bed bugs' primarily nocturnal feeding cycle. “Bed bug” is the generic term given to the cimicid family of parasitic insects and cimex lectularius, the common bed bug, is the most well known as it feeds preferably on human blood. Thus, cimex lectularius type bed bugs are often found inside and in close proximity to human sleeping areas, such as inside of beds, bedding, dressers, nightstands, bedroom closets, and related sleeping areas. Other cimex species do exist and may feed on human hosts, but are primarily preferential to other hosts.

As a result of their habitat tendencies, bed bugs are readily transmitted to other areas. For example, as people travel or move from one residence to another, they may unknowingly transport these minute creatures among their clothes, bedding, luggage, garment bags, backpacks, etc, thereby exacerbating the infestation and resurgence problem. Of particular concern are hotels, motels, and other lodging venues. A room occupant may unwittingly caravan in the bed bugs while a subsequent occupant may unknowingly become a victim to the newly entrenched insects and consequently transport them back to their own residence or other travel destination.

Bed bugs are a growing nuisance and because of their blood feeding nature, their bites often result in health issues to the human host. For example, symptoms from bed bug bites can result in various types of skin rashes, allergic reactions, and sickness, possible dispersion of diseases and viruses, and even psychological effects.

Although bed bugs can readily populate, transport, and have become a growing problem, they can generally be eradicated simply by using pesticides or exposing their environment to high or low temperatures and even high levels of carbon dioxide. For example, in a “high temperature” treatment it is known that the thermal death point for bed bugs is about 45° C. (113° F.) in egg stages, however, all life stages can be killed by about 7 minutes of heat exposure at about 46° C. (115° F.).

As disclosed herein by the bed bug elimination systems and methods, the cycle of bed bug transport, infestation, and victimization can be treated and interrupted by a high temperature treatment. Thus, to address the need to eradicate and minimize problematic bed bugs, particularly for travelers, systems and methods to provide a portable high temperature treatment are hereby presented. It should be noted that while the bed bug elimination systems and methods disclosed are primarily directed towards a high temperature treatment, a cold temperature treatment and a carbon dioxide saturation is likewise contemplated by this disclosure. Moreover, many of the systems and methods discussed below may be similarly applicable by simple adaptation and/or reconfiguration.

### SUMMARY OF THE INVENTION

Among various representative embodiments, the present invention may comprise a portable system to combat infestation and facilitate eradication of bed bugs. An exemplary embodiment may comprise a travel article and a heating mechanism, which may be integrated within the travel article to elevate an internal temperature of the travel article. The travel article may comprise a suit case, luggage, bag, backpack, garment bag, laptop bag, tote bag, purse, trunk and the like. The travel article may also comprise an integrated power source to power the heating mechanism or merely operate as a convenience to power other power needing devices.

Among various embodiments, the heating mechanism may comprise a resistive heating element, wherein the heating mechanism may comprise a temperature regulator to raise and/or maintain the internal temperature of the travel article to a temperature of at least 115° F.

Among other exemplary embodiments a system to combat infestation and facilitate eradication of bed bugs may comprise a travel article, a portable enclosure suitable for a traveler to transport the portable enclosure within the travel article, and an environment controlling mechanism to regulate an internal temperature of the portable enclosure. In an embodiment, the portable enclosure in an expanded form may comprise a volume to enclose at least one of the travel article and the travel article contents.

Among various exemplary embodiments, the environment controlling mechanism may comprise a resistive heating element and/or the environment controlling mechanism may alternately or concurrently couple to an air inlet port of the portable enclosure to receive air at an elevated temperature. The environment controlling mechanism may comprise a temperature regulator to regulate the internal temperature of the portable enclosure to a temperature of at least 115° F.

Among various representative embodiments, the present invention may comprise a method to manufacture, package, market, and/or sell the bed bug elimination system.

### BRIEF DESCRIPTION OF THE DRAWINGS

A more complete understanding of bed bug elimination systems and methods may be derived by referring to the detailed description and claims when considered in connection with the following illustrative figures. In the following figures, like reference numbers refer to similar elements and steps throughout the figures.

FIG. 1 representatively illustrates an exemplary bed bug elimination system;

FIG. 2 representatively illustrates an enclosure of the bed bug elimination system; and

FIG. 3 representatively illustrates a method of manufacturing, packaging, and marketing, a bed bug elimination system;

Elements and/or method steps in the figures are illustrated for simplicity and clarity and have not necessarily been rendered according to any particular construction or sequence. For example, steps that may be performed concurrently or in different order are illustrated in the figures to help to improve understanding of embodiments of bed bug elimination systems and methods. Similarly, elements that disclose embodiments of various devices or systems may be assembled in various fashions are illustrated in the figures to similarly improve the understanding of embodiments of bed bug elimination systems and methods.

### DETAILED DESCRIPTION OF THE INVENTION

Bed bug elimination systems and methods may be described herein by terms of various functional elements and various method steps. Such functional elements may be realized by any number of hardware components configured to perform specified functions and to achieve various results. For example, the bed bug elimination systems and methods may employ various travel articles, such as suitcases, backpacks, bags, garment bags, tote bags, laptop bags, trunks, and the like. Moreover, the travel articles may comprise various mechanisms to raise the internal temperature of the travel article, including integrated heating devices, inlet ports to introduce air at an elevated temperature, integrated power sources, displays, and control panels. The system may further comprise an integrated and/or a removable enclosure, such as a polyvinyl bag to place items for heat treating. In addition, bed bug elimination systems and methods may be practiced in conjunction with any number of bed bug infested environments, and the systems and devices described are merely exemplary applications for the invention. Further, bed bug elimination systems and methods may employ any number of conventional techniques for manufacturing, packaging, marketing, and selling the described systems and devices.

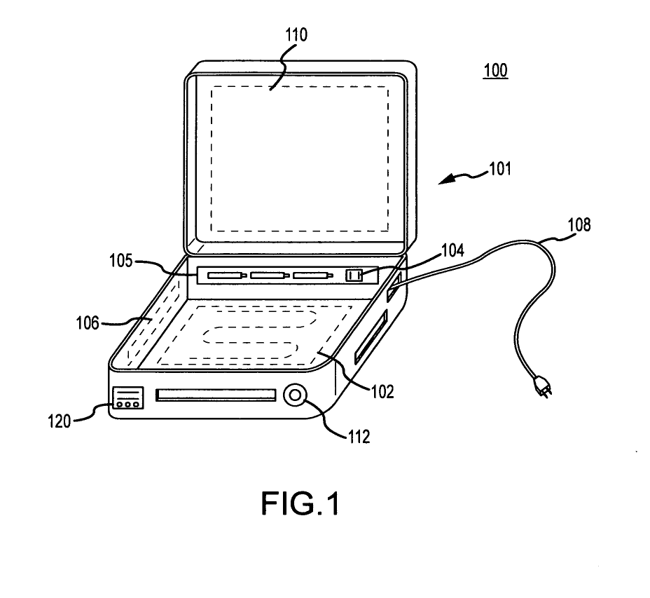

Various representative implementations of bed bug elimination systems and methods may be applied to any portable system. Referring now to FIG. 1, a bed bug elimination system 100 may comprise a travel article 101 to transport personal items, and an environmental controlling mechanism, such as heating source 102 to elevate the internal temperature of travel article 101. Bed bug elimination system 100 may further comprise an integrated power source 104 to provide power to travel article 101, as well as any other power needing devices. Travel article 101 may comprise another electrical mechanism to supply power to travel article 101, such as a power cord 108 that may couple to an external power source, not shown. In an embodiment, travel article 101 of bed bug elimination system 100 may further comprise an enclosure, such as a pouch 110, which may be integrated within travel article 101 or removable to place items for concentrated heating. Travel article 101 of bed bug elimination system 100 may also comprise a display/control panel 120 to convey temperature, time and any other status information of travel article 101 and/or to control various system 100 and/or article 101 elements. Travel article 101 may further comprise an inlet port, such as a valve 112 to allow air of an elevated temperature to be introduced and/or circulated throughout the internal compartment of travel article 101.

Among various exemplary embodiments, travel article 101 may also comprise many of the typical accessories associated with travel articles and many of these accessories may be complimentary to bed bug elimination system 100, for example, handles, telescopic or otherwise, hooks, straps, wheels, and the like.

Continuing with FIG. 1, bed bug elimination system 100 may comprise travel article 101. As shown, travel article 101 comprises a typical suitcase type article, however; other articles may be used to transport personal and the like items, which may be used to comprise bed bug elimination system 100. For example, travel article 101 may comprise a tote bag, a garment bag, a backpack, a laptop case, a trunk, a purse, a shoulder bag, a gym bag, and any other travel article now known or developed in the future. Moreover, while bed bug elimination system 100 is described with respect to an article used for travel, bed bug elimination system 100 may likewise comprise an article and/or compartment that may be generally static, i.e., not used for travel. For example, a static article might comprise a piece of home furniture, such as an ottoman, a dresser, a nightstand, a cabinet, a closet, a chest, and the like. Additionally, other compartment containing items may similarly benefit from bed bug elimination system 100, such as a car, boat, RV, truck, trailer, airplane, and the like. While many exemplary article embodiments are discussed, bed bug elimination system 100 is not limited in this regard and other dynamic or static articles and/or compartments may be treated using system 100.

Continuing with FIG. 1, bed bug elimination system 100 may comprise an environmental controlling mechanism, such as heating source 102, to raise an internal temperature of article 101. It should be noted that bed bugs can generally be eradicated simply by using pesticides or exposing their environment to high or low temperatures and even high levels of carbon dioxide. For example, in a “high temperature” treatment the thermal death point for all bed bug life stages is about 7 minutes of heat exposure at about 46° C. (115° F.). Thus, for a high temperature treatment, heating source 102 should generate heat so as to raise the internal temperature of article 101 to at least a temperature of 46° C. (115° F.).

Continuing with an exemplary embodiment, heating source 102 may be an integral heating source of article 101, but in other exemplary embodiments article 101 may comprise a heating source that is not integrated within article 101, for example the heating source may be removable for external use, repositionable, flexible, and the like. In an exemplary embodiment, heating source 102 may comprise a resistive heating element, wherein the resistive heating element may be positioned between the exterior body of article 101 and an inner lining such that the resistive heating element does not directly contact internal items so as to protect the items from direct heat. Moreover, heating source 102 may be placed within various parts of article 101, such as at the bottom of article 101, as is shown by heating source 102 in FIG. 1, or in a sidewall, as is shown by heating source 106 in FIG. 1.

While an exemplary embodiment may comprise a resistive heating element as the heating source 102, other mechanisms that can elevate the internal temperature of article 101 may be used, for example, chemical reactive components that produce an exothermic reaction may be used, microwaves, solar mechanisms, electromagnetic devices and systems, frictional elements, etc.

In other exemplary embodiments, direct heating sources, such as heating source 102, may not be used, but rather indirect devices and systems may be used to raise the internal temperature of article 101. For example and with reference to an inlet port 112 of FIG. 1, inlet port 112 may operate as a valve to allow the introduction of heated air, such as may be provided by a typical hair dryer. Alternately, rather than inlet valve 112 operating to allow the introduction of heated air to raise the internal temperature of article 101, inlet valve 112 may operate to allow the introduction of various gases (or even liquids) that may eliminate bed bugs, for example carbon dioxide gas. In such an example, a user may provide a canister of compressed carbon dioxide gas and couple it to inlet valve 112 so as to introduce and saturate the internal compartment with carbon dioxide thereby killing off the bed bugs. This alternative embodiment may be useful for users that may not wish to raise the internal temperature to article 101 or its contents, which may be susceptible to high heat. In this regard harmless carbon dioxide is an effective alternative treatment. For most exemplary embodiments, bed bug elimination system 100 relies upon article 101 to be closed and/or sealed so as to retain heat from heating source 102 and/or introduced heat or gases via inlet valve 112. Among various exemplary embodiments article 101 may comprise an inner lining and/or insulation that is resistant to heat and/or that may operate to reflect and retain an introduced heat and/or gases. In most exemplary embodiments, bed bug elimination system 100 comprises elements to raise the internal temperature of article 101 and/or allow the introduction of gases, however, other elements, devices, and/or systems may be provide to lower the internal temperature of article 101 to at least −32° C. (−26° F.), which is a low temperature treatment to kill bed bugs.

Among the various heating (or cooling) sources discussed, such sources may be capable to heat (or cool) to temperatures that fall within a wide range, for example, to temperature significantly in excess of 46° C. (115° F.) or significantly below −32° C. (−26° F.), and in some embodiments, maybe an order of magnitude higher or lower.

Continuing with heating source 102, heating source 102 may be powered by an electrical plug 108 that may be plugged into an external power supply, such as a wall outlet, battery pack, or any other external power supply mechanism. Alternately, heating source 102 may be powered by a power source that is integrated within article 101, for example a battery pack 105, and battery pack 105 may comprise replaceable or rechargeable batteries. As an additional benefit, battery pack 105 may serve not only to provide power for heating source 102, but rather as a power supply to provide power to other devices via an outlet 104. In some exemplary embodiments electrical plug 108 and/or battery pack 105 may be detachable/removable for use with other devices and/or applications.

Among various exemplary embodiments, article 101 of bed bug elimination system 100 may comprise a display 120 to convey information in digital or analog form, such as temperature, time and any other status information of travel article 101. Moreover, display 120 may further comprise control elements to control aspects of article 101. For example, controls of display 120 may regulate heating source 102, power input from plug 108 and/or battery pack 106, etc. Display 120 may be hard wired to communicate directly with various article 101 components or wirelessly. Additionally, display 120 may comprise various IC circuitry, memory, software, and the like to operate as intended. Display 120 may also communicate in hard wired or wireless form with an external PC, smart phone, tablet, and the like to exchange information, receive input and/or control various elements of article 101.

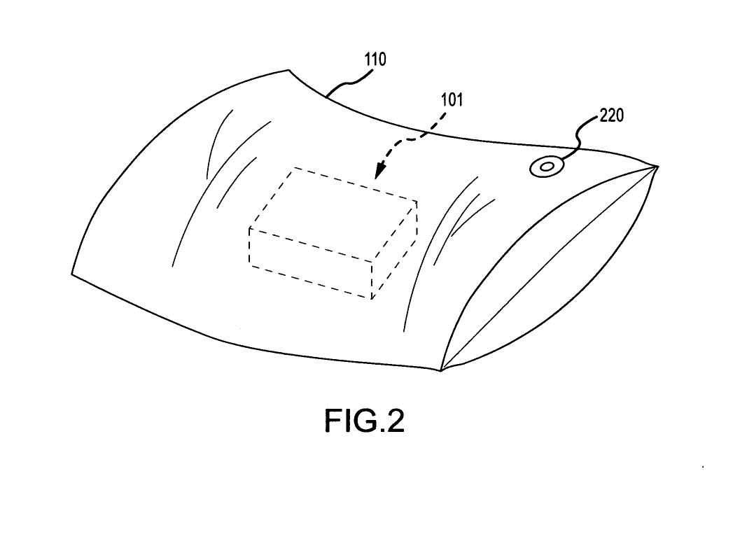

Among various exemplary embodiments, article 101 of bed bug elimination system 100 may comprise an enclosure 110, FIG. 1, which, in a folded or collapsed form, may be stowed within article 101. In an expanded form, and with reference to FIG. 2, enclosure 110 may comprise a volume that allows article 101 and/or personal contents carried by article 101 to fit within enclosure 110. Enclosure 110 may also comprise a volume to accommodate other articles, for example, quilts, bed sheets, linens, towels, and the like items that a user may choose treat. Enclosure 110 may comprise an enclosure inlet valve 220, similar to input valve 112 of article 101, to allow input of heated air to raise the internal temperature of enclosure 110 or to allow input of a gas, such as carbon dioxide. Among various exemplary embodiments, enclosure 110 may also comprise the various elements described with respect to travel article 101, such as, a display, a control panel, an integrated heating source, a power supply, configuration, material and insulation properties, and the like. Enclosure 110 may comprise a flexible, semi-flexible or stiff polymeric type material capable to secure deposited items as well as allow heating/cooling/gas induced environments to proliferate.

Bed bug elimination system 100 has been described above with respect to various functional elements that serve to enable the system to operate as intended however; other elements now known or developed in the future may be implemented. Moreover, bed bug elimination system 100 is directed toward bed bug type pests, but the system 100 may be directed towards any other type of pest, insect, vermin, bacteria, mold, virus, etc.

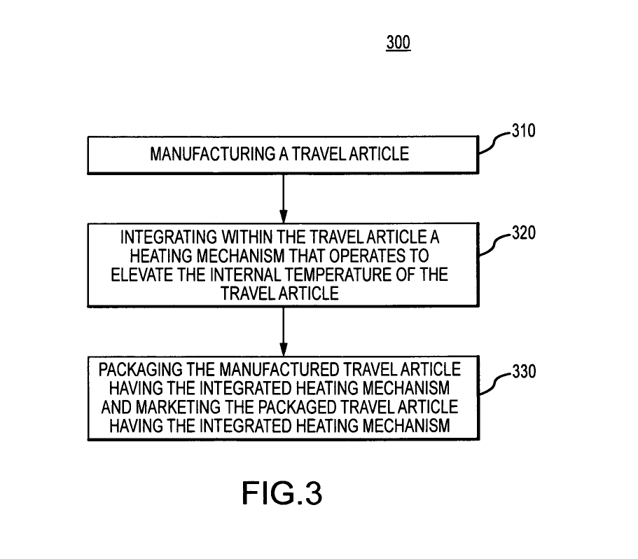

In accordance with exemplary embodiments of bed bug elimination systems and their method for manufacture, and with reference to FIG. 3, an exemplary method 300 for manufacturing a bed bug elimination system comprises: manufacturing a travel article (a block 310); integrating within the travel article a heating mechanism that operates to elevate the internal temperature of the travel article (a block 320); and packaging the manufactured travel article having the integrated heating mechanism; and marketing the packaged travel article having the integrated heating mechanism (a block 330).

Manufacturing the travel article (the block 310), similar to travel article 101, may comprise manufacturing at least one of a suit case, luggage, bag, backpack, garment bag, laptop bag, tote bag, purse, and trunk. Manufacturing the travel article (the block 310) may further comprise manufacturing various elements associated with the travel article to raise the internal temperature of the travel article, such as integrated power sources, such as battery pack 105, integrated outlets, such as outlet 104, power cords, such as power cord 108, inlet valves, such as inlet valve 120 and/or 220, and displays and control panels, such as display/control panel 120. Manufacturing the travel article may further comprise manufacturing the travel article to comprise an integrated or removable enclosure, such as enclosure 110.

Integrating within the travel article a heating mechanism that operates to elevate the internal temperature of the travel article (a block 320) may comprise integrating a heat source, similar to heat source 102 and 106, wherein the heating mechanism may comprise a resistive heating element. Moreover, the heating mechanism may comprise a temperature regulator to regulate the internal temperature of the travel article to a temperature of at least 115° F.

Among the exemplary methods described herein, and although a particular order of actions is depicted in FIG. 3 (Method 300), such actions may be performed in other temporal sequences. For example, the example the actions depicted in FIG. 3 (Method 300) may be performed sequentially, concurrently, or simultaneously. For example, block 320 may be performed before or after block 310. Other variations of exemplary methods are also contemplated by this disclosure, for example, a method of packaging the exemplary embodiments, a method of marketing the exemplary embodiments and/or a method of selling the exemplary embodiments.

The bed bug elimination systems and methods described herein may be implemented in a variety of embodiments, and the foregoing discussion of exemplary embodiments does not necessarily represent a complete description of all possible embodiments. For example, other exemplary embodiments may comprise some, all, or a combination of the embodiments disclosed. For example, alternate embodiments may comprise a combination of some or all of the embodiments depicted in FIGS. 1 and 2.

In the foregoing specification, bed bug elimination systems and methods have been described with reference to specific bed bug elimination exemplary embodiments. Various modifications and changes may be made, however, without departing from the scope of bed bug elimination systems and methods as set forth in the claims. The specification and figures are illustrative, rather than restrictive, and any modifications are intended to be included within the scope of bed bug elimination systems and methods. Accordingly, the scope of bed bug elimination systems and methods should be determined by the claims and their legal equivalents rather than by merely the examples described. For example, the steps recited in any method claims may be executed in any order and are not limited to the specific order presented in the claims. Additionally, the components and/or elements recited in any apparatus, device or system claims may be assembled or otherwise operationally configured in a variety of permutations and are accordingly not limited to the specific configuration recited in the claims.

Benefits, other advantages and solutions to problems have been described above with regard to particular bed bug elimination embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “containing”, “having”, “including”, “includes”, “is” or any variation thereof, are intended to reference a non-exclusive inclusion, such that a process, method, article, composition, device, system or apparatus that comprises a list of elements does not include only those elements recited, but may also include other elements not expressly listed or inherent to such process, method, article, composition, device, system or apparatus. Other combinations and/or modifications of the above-described structures, arrangements, applications, proportions, elements, materials or components used in the practice of bed bug elimination systems and methods, in addition to those not specifically recited, may be varied or otherwise particularly adapted to specific environments, manufacturing specifications, packaging elements, marketing efforts, design parameters or other operating requirements without departing from the general principles of the same.

I claim:

1. A portable system to combat infestation and facilitate eradication of bed bugs comprises:
a travel article;
a portable enclosure suitable for a traveler to transport the portable enclosure within the travel article; and
an environment controlling mechanism to regulate an internal temperature of the portable enclosure.

2. The system according to claim 1, wherein the travel article comprises at least one of a suit case, luggage, bag, backpack, garment bag, laptop bag, tote bag, purse, and trunk.

3. The system according to claim 2, wherein the portable enclosure in an expanded form comprises a volume to enclose at least one of the travel article and travel article contents.

4. The system according to claim 3, wherein the environment controlling mechanism comprises a resistive heating element.

5. The system according to claim 3, wherein the environment controlling mechanism couples to an air inlet port of the portable enclosure to receive air at an elevated temperature.

6. The system according to claim 1, wherein the environment controlling mechanism comprises a temperature regulator to regulate the internal temperature of the portable enclosure to a temperature of at least 115° F.

7. The system according to claim 1, wherein the travel article further comprises an integrated power source to provide power to the environment controlling mechanism.

8. A travel device to combat infestation and facilitate eradication of bed bugs comprising:
a travel article; and
a heating mechanism integrated within the travel article to elevate an internal temperature of the travel article.

9. The device according to claim 8, wherein the travel article comprises at least one of a suit case, luggage, bag, backpack, garment bag, laptop bag, tote bag, purse, and trunk.

10. The device according to claim 9, wherein the heating mechanism comprises a resistive heating element.

11. The device according to claim 10, wherein the heating mechanism comprises a temperature regulator to maintain the internal temperature of the travel article to a temperature of at least 115° F.

12. The device according to claim 11, wherein the travel article further comprises an integrated power source.

13. The device according to claim 8, wherein the heating mechanism comprises a temperature regulator to maintain the internal temperature of the travel article to a temperature of at least 115° F.

14. The device according to claim 13, wherein the travel article further comprises an integrated power source.

15. A method to eliminate bed bugs for a traveler comprising:
manufacturing a travel article; and
integrating within the travel article a heating mechanism that operates to elevate the internal temperature of the travel article.

16. The method according to claim 15, wherein manufacturing the travel article comprises manufacturing at least one of a suit case, luggage, bag, backpack, garment bag, laptop bag, tote bag, purse, and trunk.

17. The method according to claim 16, wherein the heating mechanism comprises a resistive heating element.

18. The method according to claim 17, wherein the heating mechanism comprises a temperature regulator to regulate the internal temperature of the travel article to a temperature of at least 115° F.

19. The method according to claim 18, wherein the travel article further comprises an integrated power source.

20. The method according to claim 15, further comprising;
packaging the manufactured travel article having the integrated heating mechanism; and
marketing the packaged travel article having the integrated heating mechanism.
